(19) United States
(12) Patent Application Publication
(10) Pub. No.: US 2005/0134588 A1
(43) Pub. Date: Jun. 23, 2005

(54) Method and apparatus for image processing

(75) Inventors: Timo Aila, Helsinki (FI); Tomas Akenine-Moller, Goteborg (SE)

Correspondence Address: BROWDY AND NEIMARK, P.L.L.C.;624 NINTH STREET, NW, SUITE 300, WASHINGTON, DC, 20001-5303, US

(73) Assignee: HYBRID GRAPHICS, LTD., Helsinki (FI)

(21) Appl. No.: 10/742,389

(22) Filed: Dec. 22, 2003

(51) Int. Cl. G06T 15/60

(52) U.S. Cl. 345/426

(57) ABSTRACT

A processor for image processing in accordance with shadow polygons defining together a current shadow volume is configured to determine a set of tiles, each tile being formed of a set of pixels and having a respective tile volume defined by the set of pixels and depth values relating to the set of pixels. The processor is further configured to determine whether a tile is a potential boundary tile or a non-boundary tile, a potential boundary tile having a tile volume intersected by at least one of the shadow polygons. A method and device for image processing are also discussed.

### BACKGROUND OF THE INVENTION

1. Field of the Invention

The present invention relates in general to image processing. In particular the present invention relates to efficiently determining shadow regions.

2. Description of the Related Art

In computing systems and devices, images are usually displayed on a two-dimensional screen. The images are defined by arrays of pixels. Computer graphics refers here to drawing an image representing a scene of a three-dimensional space. The three-dimensional space may relate to a virtual space or to real space. In games, for example, the scenes typically relate to a virtual space, whereas in simulations the scenes may relate to the real three-dimensional space.

When rendering a scene in computer graphics, each object in the scene is rendered (drawn). The objects are typically defined using polygons, often using only triangles. When polygons are rendered, there may be more than one polygon relating to a pixel on the screen. This happens, for example, when an object in the foreground of the scene partly or completely covers an object in the background of the scene. There is thus need to determine, which polygon is the foremost for selecting the color of the pixel correctly.

When drawing a polygon, a depth value is calculated for each pixel. If this depth value is smaller than a depth value already stored for the pixel, the polygon which is currently being drawn is in front of the polygon already stored in the pixel. A color derived from the current polygon and its attributes is therefore stored in the pixel and the respective depth value is stored in the depth buffer. The depth buffer contains depth values for each pixel of an image. The depth values are often called z values, and the depth buffer is often also called a z buffer.

Rendering of shadows is a key ingredient in computer generated images since they both increase the level of realism and provide information about spatial relationships among objects in a scene. For real-time rendering, the shadow mapping algorithm and the shadow volume algorithm are probably the two most popular techniques. The shadow mapping algorithm was presented by L. Williams in “Casting Curved Shadows on Curved Surfaces”, in Computer Graphics (Proceedings of ACM SIGGRAPH), ACM, pp. 270-274, 1978. The shadow volume algorithm was presented by F. Crow in “Shadow Algorithms for Computer Graphics”, in Computer Graphics (Proceedings of ACA SIGGRAPH 77), ACM, pp. 242-248, 1977.

Often information about shadows is called a shadow mask. The shadow mask typically indicates pixels in shadow. The shadows are then illustrated on the screen, for example, by drawing transparent gray areas defined by the shadow mask or by decrementing light for each pixel belonging to the shadow mask or by drawing the scene using full lighting only where there is no shadow. The shadow mask is typically stored in a stencil buffer. A positive value in the shadow mask typically indicates that the point is in shadow and a zero value indicates that there is no shadow. The shadow volume algorithm for determining shadows is discussed below in more detail. A shadow volume is a shadow space produced by a light source and a shadow casting object that blocks the light. The inner side of the shadow volume is the region in which the shadow casting object will cast a shadow on any object appearing in that region. The outer side of the shadow volume is lit by the light emitted from the light source. For a polygonal shadow casting object, the shadow volume is a semi-finite polyhedron with quadrilaterals called shadow quads. FIG. 1 illustrates a light source 10, a triangular shadow casting object 12, a shadow volume 14 and three shadow quads 16a, 16b, 16c. If only the shadow quads are used then the shadow volume will not be closed. Therefore, the frontfacing triangles (as seen from the light source) of the shadow caster are used to cap the top of the shadow volume. Alternatively, the backfacing triangles can be used. To close the far end of the shadow volume, triangles are created, where one edge of the triangle is from the far side of the shadow quad, and the third point is a centroid point that is shared between all far end capping triangles. A person skilled in the art understands that there are other ways of closing the shadow volume at the far end.

As mentioned above, the objects in the three-dimensional space are typically defined using triangles. For more complex objects, one usually does not create three shadow quads per shadow casting triangle. Instead, shadow quads are created only for the possible silhouette edges of an object. A possible silhouette edge is defined such that one of the two triangles that share the edge is facing away from the light source (back facing) and the other triangle is facing towards the light source (front facing). The shadow quads for the possible silhouette edges are typically called shadow polygons. Often a shadow polygon is defined using shadow triangles.

One of advantages of shadow volume algorithms is that the shadow polygons can be processed in a similar manner as polygons defining objects and surfaces in a three-dimensional scene. The shadow volume algorithm first renders the three-dimensional scene as seen by the eye using ambient lighting on all rendered surfaces, in other words, without any shadows. A color buffer containing information about the pixel colors and the z buffer containing the depth map are hereby initialized.

Thereafter a shadow mask relating to the shadow volume polygons of the shadow casting objects is generated using the shadow volume algorithm. The shadow volume polygons are typically rendered into the stencil buffer. In a third pass, the scene is rendered with full lighting with respect to those pixels that are lit. The per-pixel shadow term is read from the stencil buffer. Pixels in shadow are unaffected by the third pass, and thus contain the scene rendered using only ambient lighting, i.e., the pixels are in shadow. A person skilled in the art understands that slightly different versions of the first and third pass exist. For example, the first pass can be a full lighting pass, and the third can darken out the regions that are in shadow.

There are two alternatives for determining shadows masks, a Z-pass and a Z-fail method. In the Z-pass method, only the parts of the shadow polygons that are in front of the previously rendered geometry affect the stencil buffer. This means that the depth test mode is “less than”. For fragments that are covered by a front facing shadow polygon, the stencil buffer is incremented. For fragments that are covered by a back facing shadow polygon, the stencil buffer is decremented. This is shown in FIG. 2a, where the part of shadow polygons that affect the stencil buffer are shown using a lighter shade of gray and marked with −1 (back facing) and +1 (front facing). As the right-most panel of FIG. 2a shows, the shadow mask stored in the stencil buffer is a correct shadow cast by the object in the room.

The Z-pass method does not handle correctly cases where the eye is inside a shadow volume. The Z-fail method is discussed for example in U.S. Pat. No. 6,384,822 and by C. Everitt and M. Kilgard in “Practical and Robust Stenciled Shadow Volumes for Hardware-Accelerated Rendering”, in 2002; available at http://developer.nvidia.com/. In the Z-fail method, the depth test is reversed. In other words, only the parts of the shadow polygons that have z values larger than the contents of the z buffer affect the shadow mask. For fragments on a front facing shadow polygon that are behind the corresponding content of the z-buffer, the stencil buffer is decremented. For fragments on a back facing shadow polygon that are behind the corresponding content of the z-buffer, the stencil buffer is incremented. This is shown in FIG. 2b. As the right-most panels of FIGS. 2a and 2b show, the Z-pass and Z-fail method produce the same shadow mask in the illustrated example. The Z-fail method produces a correct shadow mask also when the eye is inside a shadow volume. Therefore the Z-fail version of the shadow volume algorithm is usually preferred.

One advantage of shadow volumes is that they are omni directional. In other words, shadows can be cast in any direction. Shadow volume algorithms do not suffer from aliasing and bias problems inherent to shadow mapping, but instead use excessively filtrate. Fillrate is a term that is loosely used to denote how many pixels that are being processed. The performance of shadow volume algorithms is proportional to the area of the projected shadow polygons.

There have been certain proposals for accelerating shadow volume algorithms. In “A Comparison of Three Shadow Volume Algorithms”, The Visual Computer 9, 1, pp. 25-38, 1992, Slater described and compared three versions, that all run in software, of the shadow volume algorithm. These use binary space partitioning tree (BSP trees) to accelerate the shadow generation, but the BSP trees do not appear to be suited for hardware acceleration.

Previous work in terms of hardware mechanisms for accelerating shadow generation seems to be close to non-existing. An exception is the UltraShadow technology of NVIDIA Corporation. The UltraShadow technology enables the programmer to limit a portion of the depth, called the depth bounds, so that shadow generation is avoided if the contents of the Z-buffer do not overlap with the depth bounds. It is thus the programmer's responsibility to define the depth bounds to a region where the shadow volumes are present. If this is done, a significant portion of rasterization of shadow volume polygons can potentially be avoided. UltraShadow performs reasonably well when the shadow volume is almost perpendicular to the viewing direction. However, when that is not the case, the depth bounds may cover a major part of the scene and the efficiency degrades significantly. Also, the UltraShadow cannot accelerate the rendering of shadowed regions, only the regions that cannot possibly be inside a shadow volume.

There is thus need for a shadow volume algorithm, which can be efficiently implemented especially in hardware.

### SUMMARY OF THE INVENTION

In accordance with a first aspect of the invention there is provided a method for image processing in accordance with shadow polygons defining together a current shadow volume, the method comprising:
determining a set of tiles, each tile formed of a set of pixels, and respective tile volumes defined by the set of pixels and depth values relating to the set of pixels, and
determining whether a tile is a potential boundary tile or a non-boundary tile, a potential boundary tile having its tile volume intersected by at least one of the shadow polygons.

In accordance with a second aspect of the invention, there is provided a processor for image processing in accordance with shadow polygons defining together a current shadow volume, said processor configured to
determine a set of tiles, each tile being formed of a set of pixels and having a respective tile volume defined by the set of pixels and depth values relating to the set of pixels, and
determine whether a tile is a potential boundary tile or a non-boundary tile, a potential boundary tile having a tile volume intersected by at least one of the shadow polygons.

In accordance with a third aspect of the invention, there is provided a processor for image processing in accordance with shadow polygons together defining a current shadow volume, the processor comprising
a first determining unit for determining a set of tiles, each tile being formed of a set of pixels and having a respective tile volume defined by the set of pixels and depth values relating to the set of pixels, and
a second determining unit for determining whether a tile is a potential boundary tile or a non-boundary tile, a potential boundary tile having a tile volume intersected by at least one of the shadow polygons.

In accordance with a fourth aspect of the invention, there is provided a device for image processing in accordance with shadow polygons together defining a current shadow volume, said image processing device having a processor configured to
determine a set of tiles, each tile being formed of a set of pixels and having a respective tile volume defined by the set of pixels and depth values relating to the set of pixels, and
determine whether a tile is a potential boundary tile or a non-boundary tile, a potential boundary tile having a tile volume intersected by at least one of the shadow polygons.

In accordance with a fifth aspect of the invention, there is provided a computer readable recording medium that records an image processing program code for image processing in accordance with shadow polygons together defining a current shadow volume, said image processing program code having computer execute procedures comprising:
a first determining procedure for determining a set of tiles, each tile formed of a set of pixels, and respective tile volumes defined by the set of pixels and depth values relating to the set of pixels, and
a second determining procedure for determining whether a tile is a potential boundary tile or a non-boundary tile, a potential boundary tile having its tile volume intersected by at least one of the shadow polygons.

In accordance with a sixth aspect of the invention, there is provided a processor for image processing, said processor comprising an information store for shadow information, said processor being configured to determine shadow information and to store shadow information in said information store, wherein said information store has tile-specific entries, each tile being formed of a set of pixels, for storing information indicating at least a piece of shadow information for a tile and whether at least one further entry of said information store defines further shadow information for the tile.

In accordance with a seventh aspect of the invention, there is provided a device for image processing, said device comprising an information store for shadow information, said device being configured to determine shadow information and to store shadow information in said information store, wherein said information store has tile-specific entries, each tile being formed of a set of pixels, for storing information indicating at least a piece of shadow information for a tile and whether at least one further entry of said information store defines further shadow information for the tile.

In accordance with an eighth aspect of the invention, there is provided a method for image processing, said method comprising:
determining shadow information, and
storing in a tile-specific entry of an information store, a tile being formed of a set of pixels, information indicating a piece of shadow information for a tile and whether at least one further entry of said information store defines further shadow information for the tile.

### BRIEF DESCRIPTION OF THE DRAWINGS

FIG. 1 shows schematically a light source, a shadow casting object, a shadow volume and shadow polygons,

FIG. 2a shows effects of the shadow polygons to a stencil buffer in a Z-pass version of a shadow volume algorithm in a specific example,

FIG. 2b shows effects of the shadow polygons to a stencil buffer in a Z-fail version of a shadow volume algorithm in the same example,

FIG. 3 shows three tiles A, B and C relating to the same example,

FIG. 4 shows, as an example, a schematic flowchart of a shadow volume algorithm in accordance with an embodiment of the invention,

FIG. 5 shows, as an example, a schematic drawing of an image processing device in accordance with an embodiment of the invention,

FIG. 6 shows, as an example, schematically positioning and connections of a single-pass shadow volume algorithm inside a programmable graphics processor in accordance with an embodiment of the invention,

FIG. 7 shows some examples in post-perspective space,

FIG. 8 shows an example of carrying out image processing in accordance with an embodiment of the invention by software using a general-purpose computer, and

FIG. 9 shows examples of storing shadow information for a tile in a hierarchical manner.

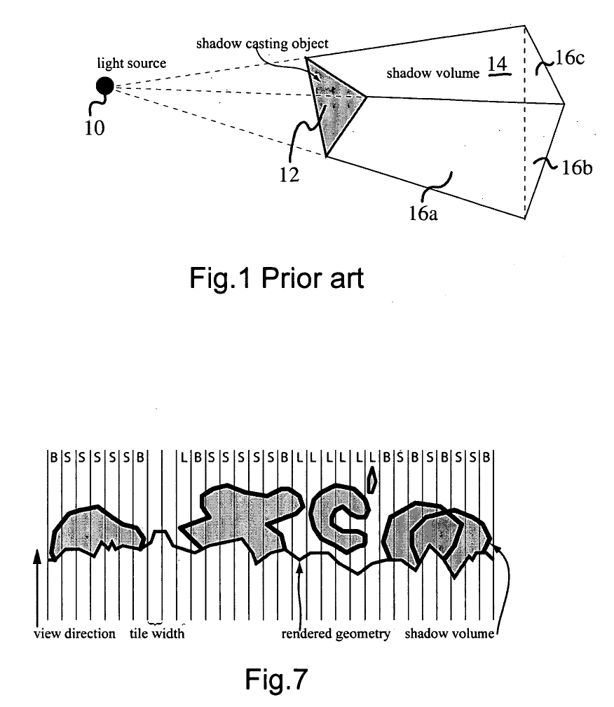

### DESCRIPTION OF THE SPECIFIC EMBODIMENTS

In the following specific embodiments of the present invention are described with reference to the attached drawings. The technical scope of the present invention is, however, not limited to these embodiments.

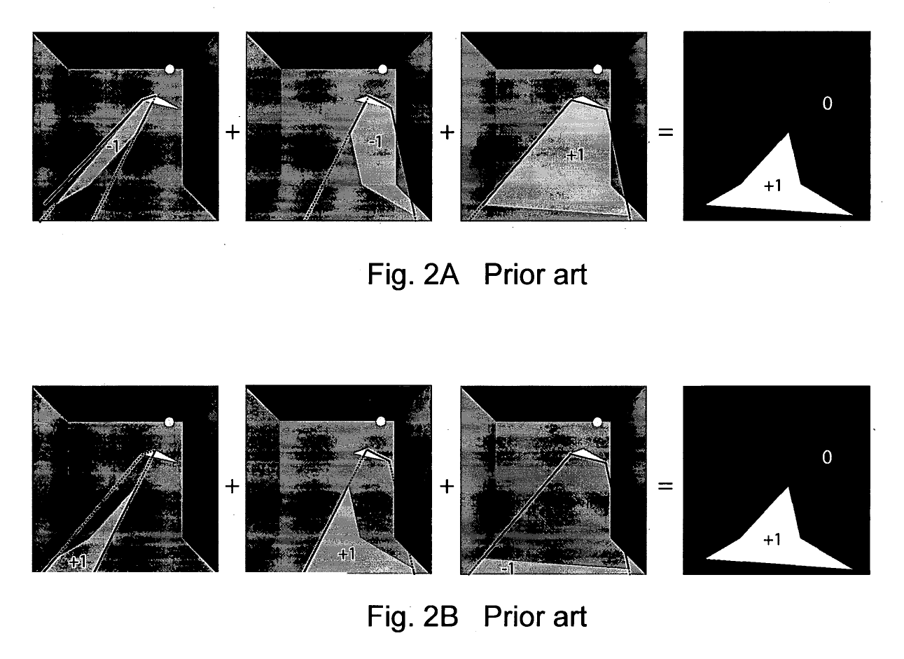

It is appreciated that a general outline of a shadow volume algorithm was given above in connection with the description of the related art. In the following embodiments, the Z-fail version of the shadow volume algorithms is used as an example. It is, however, appreciated that the Z-pass version is equally applicable, with its known limitations relating to the eye in shadow. The Z-fail and Z-pass algorithms are discussed briefly above in connection with FIGS. 2a and 2b.

It is appreciated that shadow information and information relating to tile classifications may be stored in any store for storing information. In the following description, a buffer is used as an example of an information store. In other embodiments, one may use an on-chip cache together with an external memory storage, and in other embodiments, one may use only on-chip memory.

A shadow mask is typically stored in a stencil buffer, and the following description is consistent with this practice. It is, however, clear to one skilled in the art that shadow mask or other shadow information may be stored in a buffer, which is not a stencil buffer, or in other information store.

When images are processed, the frame buffer (including the color buffer and the z buffer) containing pixels of an image is typically divided into sets of pixels often called tiles. The tiles are often non-overlapping rectangular areas. For example, an image can be divided into non-overlapping 8×8 pixel regions. Other shapes and sizes can be used as well, but often the tiles are square or rectangular. The size of the tiles may vary, but especially for hardware implementations fixed-size tiles are used. It is possible also to use slightly overlapping tiles, so that adjacent tiles share some common pixels. The term tile in this description and in the appended claims refers to a set of pixels adjacent to each other; the shape of the area defined by the tile is not restricted to any specific shape.

To accelerate rendering of an image, the following extra information is often stored for each tile: the minimum of all depth values in the tile, zₘᵢₙ, and the maximum of all depth values in the tile, zₘₐₓ. It is appreciated that for processing shadow information more efficiently, a new concept may be introduced. The perimeter of the tile and the minimum and maximum depth values define a tile volume. For a rectangular tile, for example, the tile volume is a three-dimensional axis-aligned box in screen space, defined by the horizontal and vertical bounds of the rectangular tile together with the zₘᵢₙ and zₘₐₓ values.

It is appreciated that the tile volume need not necessarily be defined using the minimum and maximum depth values relating to a tile. A tile volume can be determined using the depth values relating to a tile in a different way. An alternative is, for example, the use of two planes: one plane in front of all depth values relating to a tile, and the other plane behind the depth values, for instance. The planes can be determined based on the depth values relating to the tile. The zₘᵢₙ and zₘₐₓ values are, however, a very convenient way to define the tile volume, as this information is typically available.

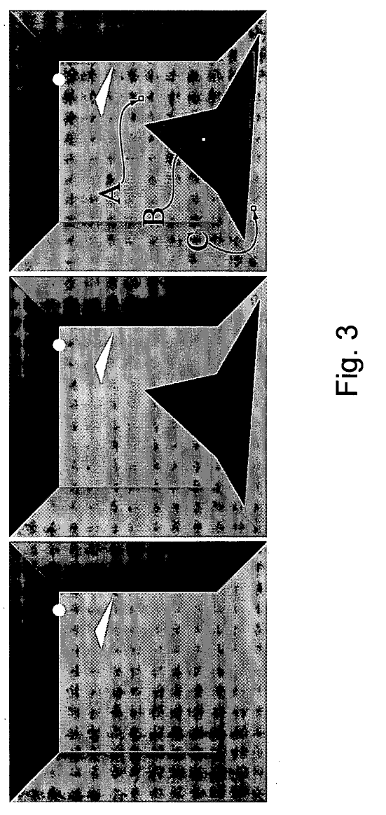

With reference to FIG. 3, the computations relating to generating a shadow mask are now discussed. The left-most panel of FIG. 3 shows a scene without shadows, although a light source and a shadow casting object are illustrated. The middle panel of FIG. 3 shows the scene with the correct shadows.

When the shadow polygons are processed using the Z-fail algorithm, it is appreciated that those parts of the shadow polygons that are completely in front of previously rendered geometry, cannot affect the shadow mask. It is therefore noted that there is no need to process these parts of the shadow polygons in the Z-fail algorithm. Two different categories of shadow polygons remain: shadow polygons that are completely hidden behind the previously rendered geometry and shadow polygons that intersect with the tile volume of a tile.

It is noted that a shadow volume is closed by definition, and that a tile can contain a shadow boundary only if the tile volume is intersected by a shadow volume polygon. If the tile volume is not intersected by a shadow polygon, the tile is either fully lit or fully in shadow with respect to the shadow volume defined by the shadow polygons. All shadow polygons relating to a specific shadow volume need to be processed before it is possible to determine those tiles, whose tile volume is intersected by at least one shadow polygon relating to a specific shadow volume. These tiles are referred to as potential boundary tiles. The tiles, whose tile volume is not intersected by any shadow polygon of the current shadow volume, are here referred to as non-boundary tiles. It is possible that a tile is fully lit or fully in shadow with respect to the current shadow polygon, even if it is classified as a potential boundary tile. It is appreciated, however, that the produced shadow mask is correct also for these cases.

The classification of tiles into tiles fully lit and tiles fully in shadow is discussed next with reference to the right-most panel of FIG. 3, which shows three tiles A, B and C. All these tiles A, B and C are covered by shadow polygons, as can be seen from FIGS. 2a and 2b relating to the same example. For tile A, the entire shadow volume is in front of the tile volume. Thus the tile is fully lit, and per-pixel work for tile A can be avoided. It is noted that existing shadow volume algorithms that use the Z-fail method are able to handle tile A without per-pixel processing, since they can cull processing of those shadow quads using the Z-min technique. This is presented by T. Akenine-Möller and J. Strom, in “Graphics for the Masses: A Hardware Rasterization Architecture for Mobile Phones”, in ACM Transactions on Graphics 22, 3 (July), pp. 801-808, 2003.

For tile B, there is one shadow polygon in front of the tile volume and a second shadow polygon completely behind the tile volume. Tile B is therefore in shadow. Tile C is covered by two shadow polygons, which are both behind the tile volume. Because one of the shadow polygons is backfacing and the other is front facing, the entire tile C is fully lit. It is noted that per-pixel processing can be avoided for tiles B and C. Existing shadow volume algorithms that use the Z-fail method are not able to optimize shadow polygon processing for tiles B and C.

For non-boundary tiles, which are either fully lit or fully in shadow, it is sufficient to carry out the shadow volume algorithm for one point inside the tile or on the edges of the tile. The result of this point applies to the whole tile. If the point is lit, the tile is fully lit. If the point is in shadow, the tile is fully in shadow. It is thus sufficient to process shadow information for non-boundary tiles on a tile level. Processing shadow information on a tile level refers here to the fact that the whole tile is processed in a similar manner after determining whether the tile is fully lit or fully in shadow.

For potential boundary tiles, shadow volume algorithm needs to be carried out on a finer resolution than on a tile level. Referring to the right-most panel of FIG. 3, the potential boundary tiles are marked there using a darker gray. It is appreciated that the amount of pixels, for which per-pixel processing is needed, is much smaller than for conventional shadow volume algorithms.

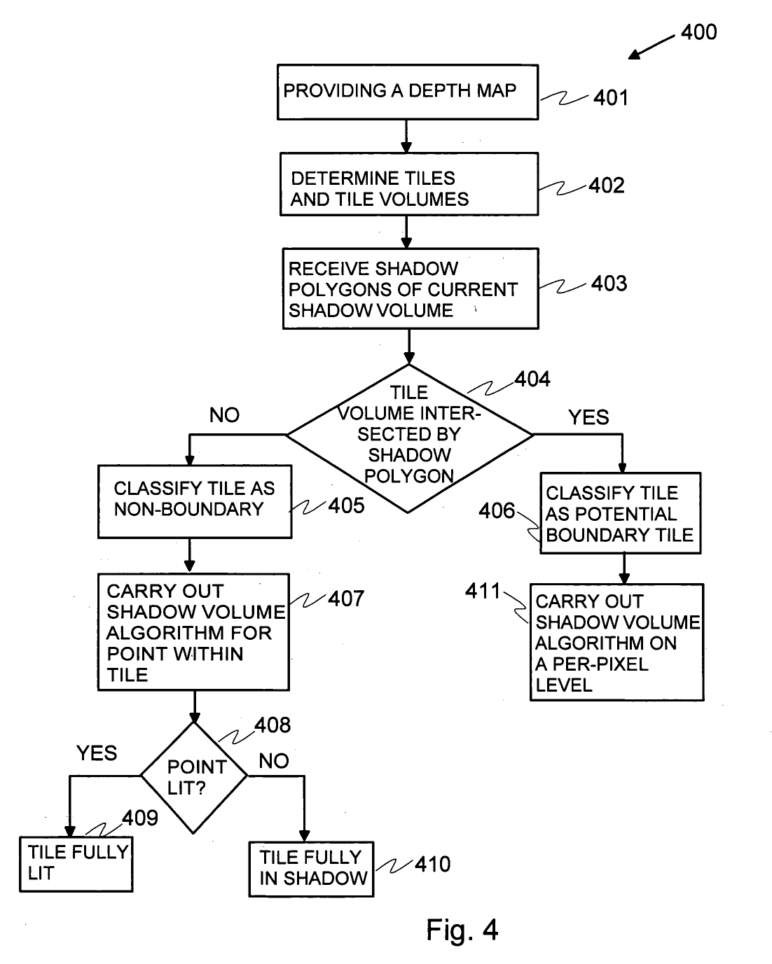

FIG. 4 shows a schematic flowchart of a method 400 for image processing in accordance with shadow polygons together defining a shadow volume. In step 401, information of the depth buffer of the previously rendered geometry is provided. The previously rendered geometry is typically stored in a frame buffer (which includes a color buffer and a depth buffer, among other things) and the respective depth map is typically stored in a z buffer. In step 402, a set of tiles and the respective tile volumes are determined. In step 403, information is received about the shadow polygons defining a current shadow volume. In step 404, it is determined for each tile whether at least one of the shadow polygons potentially intersects the tile volume. It is possible to determine whether any one of the shadow polygons relating to the current shadow volume actually intersects the tile volume, but typically the intersections are determined in a conservative manner. This means that at least the actual intersections are found. It is furthermore noted that, as mentioned above, a shadow polygon intersecting a tile volume does not necessarily mean that the tile is a boundary tile.

If the tile volume is not intersected, the tile is classified as a non-boundary tile in step 405. If the tile volume is intersected, the tile is classified as a potential boundary tile in step 406. For the non-boundary tiles, a shadow volume algorithm is carried out for one point within a non-boundary tile in step 407. Thereafter it is determined in step 408 whether the point is lit or in shadow. If the point is lit, the non-boundary tile is classified as a tile fully lit in step 409. If the point is in shadow, the non-boundary tile is classified as a tile fully in shadow in step 410. It is appreciated that the shadow volume algorithm may be carried out for more than one point in step 407, but this is waste of resources, as the result is correctly indicated by any point within a non-boundary tile. For the potential boundary tiles, a shadow volume algorithm is carried out on a per-pixel basis in step 411. In this method 400, the potential boundary tiles are thus not iteratively divided in smaller tiles.

Next some possible hardware implementations of the shadow volume algorithm are discussed. The following detailed examples relate to a graphics processor, which is a processor specifically designed for processing image information for displaying on a display or screen or for printing. A graphics card and a graphics accelerator are examples of devices, which contain a graphics processor or otherwise implement the functionality of a graphics processor. Embodiments of the invention are applicable to image processing processors and apparatus forming an integral part of a computing device. Alternatively, embodiments of the invention are applicable in add-on parts. It is furthermore appreciated that the ideas of classifying tiles into non-boundary and potential boundary tiles may be implemented in software.

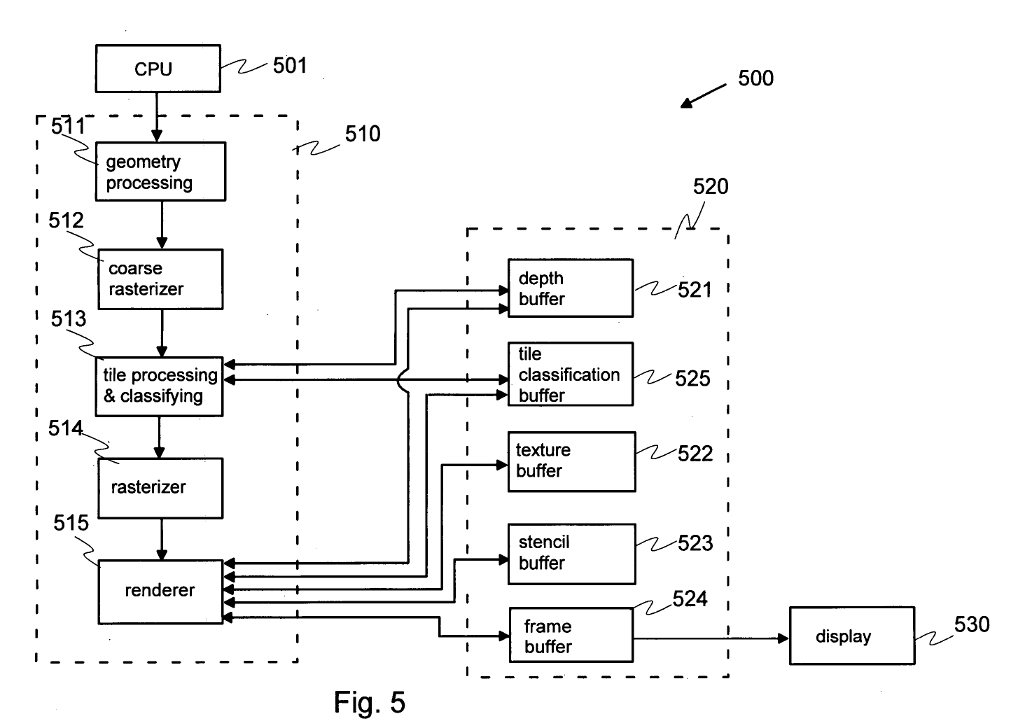

FIG. 5 shows, as an example, a schematic drawing of an image processing device 500 in accordance with an embodiment of the invention. The image processing device 500 contains a central processing unit CPU 501, a graphics processor 510, information stores 520 and a display 530. Various buffers are shown in FIG. 5 as examples of information stores. The information stores 520 may be on the same chip as the graphics processor 510, or external memory elements may be used. The information stores on external memory elements may be accessed via caches provided on the same chip as the graphics processor 510. The stencil buffer 523 is used as an example of an information store for shadow information. The graphics processor 510 may be on the same chip as the central processing unit CPU 501, or it may be implemented on a separate chip.

An application running on the central processing unit CPU 501 provides information defining the three-dimensional scene to be displayed. The geometry processing unit 0.511 of the graphics processor 510 converts, if necessary, the information defining the three-dimensional scene into polygons (typically triangles) and carries out necessary transformations and perspective projections. The coarse rasterizer 512 divides the input primitives (polygons) representing a scene into tiles.

It is noted that polygons defining geometry and shadow polygons can be processed in a similar manner. The difference is that when shadow polygons are rendered, writing to the depth buffer 521 and to the color buffer (that is, to the frame buffer 524) is disabled because the shadow polygons are not real geometry that should be visible in the final image. The shadow polygons are used only for creating/updating the shadow mask in the stencil buffer. The graphics processor 510 is thus configured to process shadow polygons in the manner described below.

The tile processing unit 513 in the graphics processor 510 is responsible for determining tile volumes using depth information stored in the depth buffer 521 (cf step 402 in FIG. 4). The tile processing unit 513 is also responsible for tile classification. The tiles are classified into potential boundary tiles and non-boundary tiles, and the tile processing unit 513 thus relates also to steps 404 to 406 shown in FIG. 4. Tile classification information indicating whether a tile is a potential boundary tile or a non-boundary tile may be stored in a temporary tile classification buffer 525 or in another information store. The temporary tile classification buffer may contain, for example, a Boolean boundary value for each tile. For non-boundary tiles the Boolean boundary value is set to value FALSE and for potential boundary tiles to TRUE. It is clear that it is not relevant whether a TRUE value or a FALSE value indicates a potential boundary tile. Furthermore, it is clear to one skilled in the art that other information than Boolean values may be used to indicate the potential boundary tiles and non-boundary tiles. Also, the temporary tile classification buffer may contain a stencil value per tile that is used to perform the shadow volume algorithm on a per-tile level, so that non-boundary tiles can be classified into fully lit or fully in shadow.

The rasterizer 514 converts a polygon into pixels or samples inside the polygon. The renderer 515 computes the color for each pixel using color and texture information stored in a texture buffer 522 and shadow information stored in the stencil buffer 523. The renderer 515 also updates the depth values in the depth buffer 521. The pixel colors are stored in the frame buffer 524. The image stored in the frame buffer 524 is then displayed on a display 530.

The renderer 515 typically processes polygons relating to objects on the scene on a per-pixel basis. The renderer 515 is adapted to process shadow polygons of a current shadow volume so that boundary tiles are processed on a per-tile basis and potential boundary tiles are processed on a per-pixel basis. The tile classification information is available in the temporary tile classification buffer 525. The functionality of the renderer 515 relates to steps 407 to 411 of FIG. 4. For non-boundary tiles, the renderer 515 stores pixel-specific shadow information in the stencil buffer 523 based on carrying the shadow volume algorithm for one point within the tile. For potential boundary tiles, the renderer 515 carries out the shadow volume algorithm on a per-pixel level and stores pixel-specific shadow information in the stencil buffer 523.

It is appreciated that some delaying elements may be needed in the image processing device 500 for enabling the tile classification in the tile processing and classifying unit 513 to be ready before the renderer 515 starts to access the boundary buffer 525.

It appreciated that although in FIG. 5 a separate graphics processor 510 is shown to contain the units 511-515, these may be integrated with other processing units of the image processing device 500. The graphics processor 510 may be implemented on a single integrated circuit.

In general, a graphics processor accepts geometric objects as input, and produces an output image of the data. As discussed above, the input objects can be defined, for example, by using triangles, quads or parametric curved surfaces. Typically all of these are converted into triangles internally in the graphics processor. Each triangle undergoes various stages, for example, transformations, perspective, conversion to pixels, per-pixel visibility test, and color computation. The whole process is called the rendering pipeline, and can be hundreds of stages long. In high-performance implementations, most or all of the stages execute simultaneously, and a number of triangles can occupy different parts of the pipeline at the same time. The triangles flow through the pipeline in the order submitted by an application. Adding new stages to the pipeline does not, in most cases, slow the graphics processor down, but makes the hardware implementation bigger instead.

It is possible to implement the entire rendering pipeline on a general-purpose CPU. However, a typical high-performance implementation includes at least some graphics-specific hardware units. Graphics hardware is normally characterized by separate hardware units assigned for different parts of the rendering pipeline. Referring to FIG. 5, for example, the units 511 to 515 may be separate hardware units. Alternatively, the functionality of some or all of these units may be provided as a single hardware unit. Most graphics processors include several programmable units for dedicated purposes, for example, for computing the color of pixels.

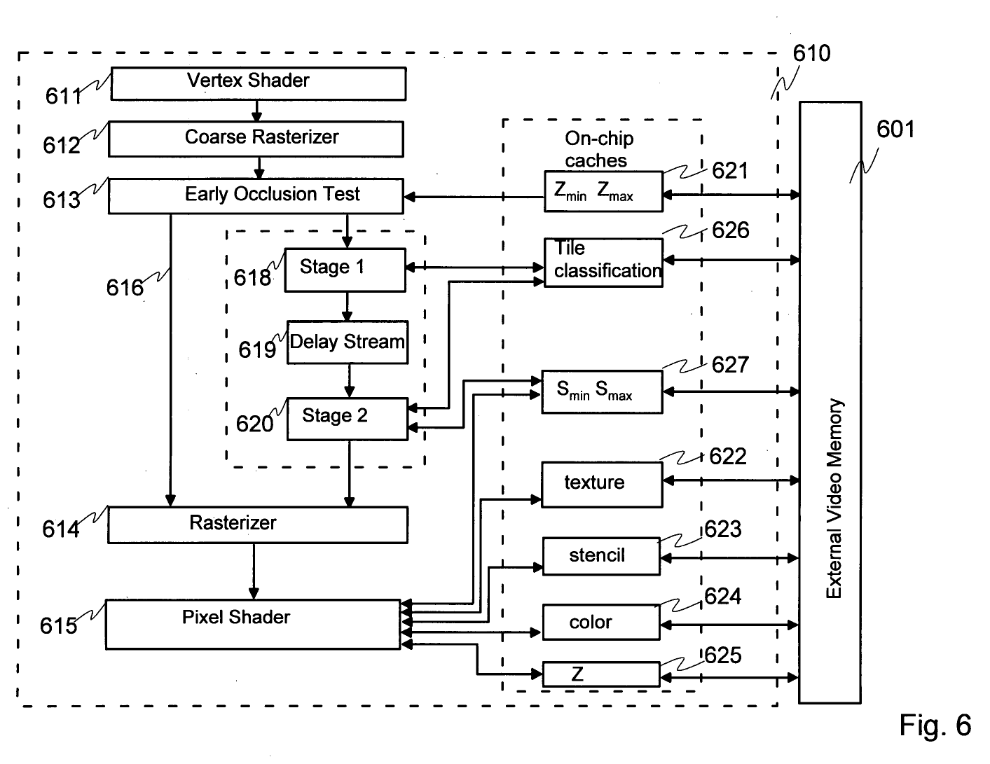

FIG. 6 shows, as an example, schematically positioning and connections of a single-pass shadow volume algorithm inside a programmable graphics processor 610 in accordance with an embodiment of the invention. Single-pass means that the shadow polygons are supplied to the graphics processor once. This single-pass algorithm in accordance with an embodiment of the present invention has two stages. In a first stage, the tiles are classified into potential boundary tiles and non-boundary tiles, and the boundary tiles are furthermore classified into tiles fully lit or fully in shadow. In a second stage, the potential boundary tiles are processed on a per-pixel level.

In the following description, it is assumed that the frame buffer is divided to fixed-sized tiles, where each tile is a rectangular set of pixels. For each tile, the Zₘᵢₙ and the zₘₐₓ values of the z buffer are maintained. The shadow mask is stored in a buffer for storing shadow information. In this embodiment, the stencil buffer is again used as an example of an information store for storing shadow information.

Referring to FIG. 6, the external video memory 601 contains various buffers, for example, the color buffer, the z buffer, the stencil buffer, and a texture buffer. The graphics processor 610 receives geometry information as input from the external video memory and processes this information for rendering shadows. The graphics processor 610 has on-chip caches for quickly accessing the information in the buffers of the external video memory. FIG. 6 shows a cache 621 for storing the tile-specific zₘᵢₙ and zₘₐₓ values and caches for the texture buffer (cache 622), the stencil buffer (cache 623), the color buffer (cache 624), and the z buffer (cache 625).

As mentioned above, polygons defining geometry and shadow polygon can be processed in a similar manner. The Vertex Shader 611 usually applies transformations and perspective projection to vertices. It may also compute lighting (without shadows). The Vertex Shader 611 performs similar functions as the geometry processing unit 511. The Coarse Rasterizer 612 converts triangles to pixels on tile level, similarly as the coarse rasterizer 512. The Early Occlusion Test 613 determines whether all the pixels/fragments belonging to a tile, are hidden or visible. The Rasterizer 614 converts triangles to pixels (or fragments), similarly as the rasterizer 514. The Pixel Shader 615 computes the color of the pixels, and its function is similar to the function of the renderer 515.

The differences between processing shadow polygons and polygons defining objects in the scene is shown explicitly in FIG. 6. The non-SV path 616 in FIG. 6 indicates how polygons defining geometry are processed in the graphics processor 610. The SV path 617, on the other hand, indicates shadow polygon processing in accordance with an embodiment of the present invention. The SV path 617 comprises Stage 1 (block 618 in FIG. 6) for classifying tiles, a Delay Stream 619 for storing shadow polygon information, and Stage 2 (block 620 in FIG. 6) for processing potential boundary tiles in more detail.

The following description is focused on processing shadow information in the graphics processor 610 using the single-pass algorithm. The graphics processor 610 is explicitly made aware that it is processing a shadow volume. This way the graphics processor can process the polygons using the shadow volume path 617, not using the non-SV path 616. Informing the graphic processor 610 that it is processing a shadow volume is the only modification that is visible to an application. This can be done, for example, by defining suitable extensions to an application programming interface (API). For example, in OpenGL API the following extensions can be defined:
glBeginShadowVolume( )
glEndShadowVolume( )
   The first stage 618 (Stage 1) of the single-pass algorithm begins when the graphics processors is informed of the beginning of a shadow volume (first shadow polygon). In Stage 1 the tiles are classified as fully lit, fully in shadow or potentially containing a shadow boundary. This classification depends on the shadow volume as a whole, and remains incomplete until the end of the shadow volume is encountered (last shadow polygon). The tile classification is performed using a temporary tile classification buffer (cache 626), which stores a value indicating whether a tile, if a non-boundary tile, is fully lit or in shadow, and a Boolean boundary value for each tile. The value indicating whether a tile is fully lit or in shadow is typically an 8-bit value similar to a stencil value. The temporary tile classification buffer 626 is initialized with a boundary value FALSE and a stencil value S_{clear}.

The shadow volume polygons are processed in the graphics processor 610 in the order submitted by the applications. If a shadow volume polygon intersects the tile volume of a tile, there is a potential shadow boundary in the tile. Such tiles are marked by setting their boundary value to TRUE in the tile classification buffer 626. The intersections need to be computed in a conservative manner, that is, at least all the actual intersections are to be marked. Any tile can be classified as a potential boundary tile without introducing visual artifacts. It is appreciated that the information needed for determining whether a shadow polygon intersects a tile volume and whether the shadow polygon is behind the tile volume is available from the Early Occlusion Test unit 613. The Early Occlusion Test unit 613 determines whether a triangle is hidden with respect to a tile volume, or if it intersects the tile volume. This is done in order to perform occlusion culling using zₘₐₓ. Therefore, the answers need not be recomputed, they can be routed from the previous unit.

If none of the shadow volume polygons intersects with a tile volume, the Boolean boundary value in the temporary buffer is still set to FALSE for the respective tile in the temporary tile classification buffer 626. In this case, the whole tile is either fully lit or in shadow. This classification can be carried out by executing the shadow volume algorithm for a single point inside the tile. The choice of the point is arbitrary, because all points give the same answer. The shadow volume algorithm carried out on a tile-level in Stage 1 sets the values indicating whether a tile is fully lit or in shadow in the temporary tile classification buffer 626 for at least the non-boundary tiles.

It is appreciated that the shadow volume polygons are processed only once in this first stage 618. After the entire shadow volume has been processed, the corresponding tile classifications are ready. If the Boolean boundary value in the temporary tile classification buffer is TRUE for a tile, this needs to be rasterized using a finer resolution, for example, using per-pixel resolution. Otherwise the rasterization can be skipped, because the entire tile is either in shadow or lit. In most implementations, a stencil value, which is larger than S_{clear}, indicates shadow.

For being able to carry out shadow volume algorithm for the potential boundary tiles on a finer resolution, the shadow polygons defining the current shadow volume are temporarily stored in the Delay Stream 619. The delay stream should be big enough to hold all shadow polygons in order to delay the stencil buffer rasterization up to the point where the classification of tiles in the first stage is complete. Typically the geometry defining a shadow volume consumes only a small amount of memory. In certain pathological cases the allocated delay stream may not be able to store the entire shadow volume. If this happens, the stencil buffer rasterization in Rasterizer 614 has to start before the tile classification in Stage 1 is complete. Visual artifacts can be avoided by treating all tiles as boundary tiles until the classification finishes, and after that skipping the per-pixel rasterization in Stage 2 only for the tiles that were classified to be fully in shadow.

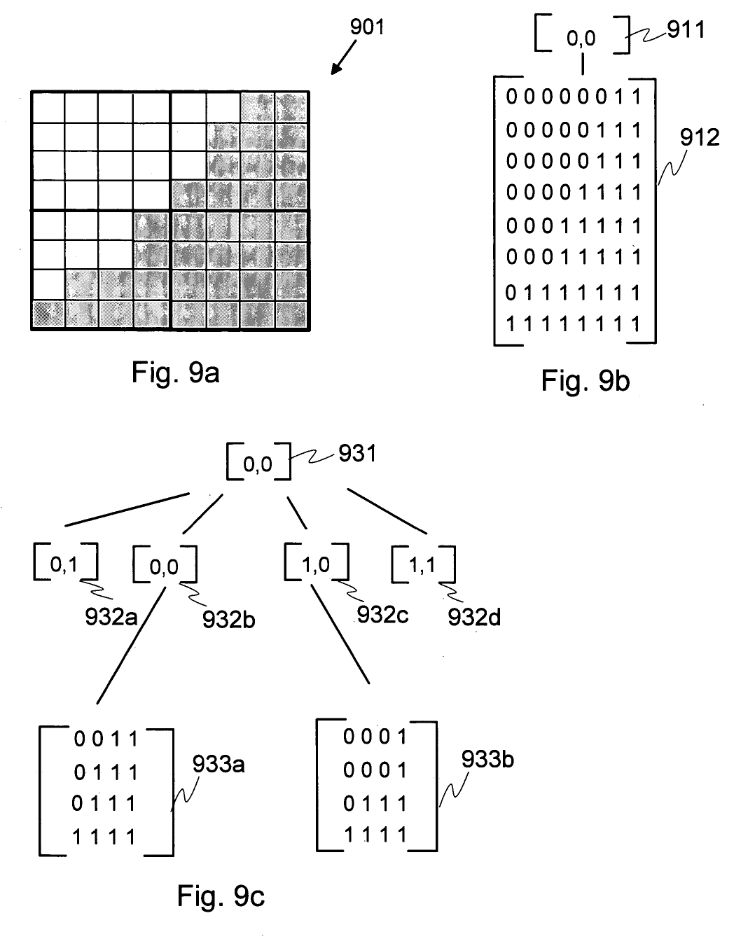

To further enhance the performance of the graphics processor, it is possible to use a hierarchical stencil buffer or other hierarchical information store for shadow information. Hierarchical information stores for shadow information are discussed in more detail below in connection with FIG. 9. A two-level stencil buffer, for example, contains tile-specific entries and pixel-specific entries. In FIG. 6, the pixel-specific stencil buffer is the stencil buffer 623, and the tile-specific entries of the stencil buffer are shown with the buffer 627. The tile-specific entries indicate, for example, the maximum and minimum stencil values Sₘᵢₙ, Sₘₐₓ for a tile. This means that if the result of the stencil test can be determined from a tile-specific entry of the hierarchical stencil buffer, the per-pixel stencil buffer entries need not be accessed.

In Stage 2 (block 620 in FIG. 6) together with the rasterizer 614 and the pixel shader 615, the shadow volume algorithm is carried out for the potential boundary tiles on a per-pixel level. The potential boundary tiles are rendered as usual with per-pixel processing (blocks 614 and 615 in FIG. 6) and at that time, the stencil buffer is updated accordingly. It is possible to update pixel-specific and tile-specific entries of the stencil buffer for all tiles. Alternatively, it is possible to use information about boundary/non-boundary tile classification in updating the stencil buffer. For boundary tiles and for potential boundary tiles that are actual boundary tiles, only the pixel-specific entries of the stencil buffer may be updated or both the pixel-specific entries and the tile-specific entries may be updated. For non-boundary tiles and for potential boundary tiles that are non-boundary tiles, it is sufficient to update only the tile-specific entries, but also here both the tile-specific and the pixel-specific entries may be updated. It is noted that in practice pixel-specific entries are usually updated for all potential boundary tiles. Update of tile-specific entries for boundary tiles is sufficient especially if other units accessing the information in the hierarchical stencil buffer access first the tile-specific entries and access the pixel-specific entries only when necessary. In other words, it is possible to determine the need to access pixel-specific entries based on the content of a respective tile-level entry. For fully lit tiles, the rasterization is typically skipped. For tiles fully in shadow, the stencil buffer is updated so that the tiles in shadow with respect to the current shadow volume are marked to be in shadow. The shadow mask thus grows monotonically. For boundary tiles, per-pixel rasterization is performed.

There are at least two ways to implement the graphics processor 610 in FIG. 6. The Stage 2 may perform coarse rasterization to determine the tiles, and also access Zₘᵢₙ/Zₘₐₓ to determine whether tile is visible or not. This can be done by having a second coarse rasterizer unit and a second early occlusion test unit as part of Stage 2. An alternative is to route the relevant information from Stage 1 by embedding it into the delay stream. That is a realistic option too, but as the coarse rasterizer unit and the early occlusion test unit are not particularly big or expensive hardware units, it may be easier and more economical to replicate them.

Usually there are multiple objects casting shadows from a light source. When the contribution of the shadow volume is added to the stencil buffer, the overall area covered by shadow grows monotonically. Therefore a tile that has been classified to be in shadow with respect to previous shadow volumes cannot be downgraded, for example, into a boundary tile in Stage 2 in FIG. 6. All rasterization to a tile can thus be skipped in Stage 2 in FIG. 6, if a tile-specific entry in the hierarchical stencil buffer indicates that the tile is already in shadow when a new shadow volume begins. When the contribution of the light source is accumulated into the frame buffer, the pixel-specific entries of the hierarchical stencil buffer need to be accessed only for boundary tiles of the combined shadow area of all shadow volumes.

In the third pass of the entire shadow volume algorithm, the contribution of the light source is accumulated into the frame buffer by reading the shadow mask from the stencil buffer.

It is noted that the proposed hardware algorithm shown in FIG. 6 is fully automatic with the exception of a pair of calls needed for marking the beginning and end of a shadow volume. The classification of tiles into three classes (fully lit, in shadow, boundary tiles) together with the hierarchical rendering technique using the hierarchical stencil buffer, the amount of per-pixel processing and bandwidth to external memory are primarily affected by the screen-space length of the shadow border, instead of the covered area. Total bandwidth requirements for our algorithm, as compared to UltraShadow, are reduced by a factor of 2-10.

FIG. 6 shows a graphics processor 610, where a delay stream 619 is used to store the shadow polygons temporarily. Alternatively, it is possible that an application supplies the shadow polygons relating to a shadow volume twice. In this case the graphics processor is informed that the shadow polygons are provided for the first time and for the second time; this way the graphics processor can process them either using Stage 1 or Stage 2. In this case, the Stage 2 unit 620 does not have to duplicate the coarse rasterizer and early occlusion test units.

In FIG. 6, various buffers are marked as on-chip caches. Basically there are two options for implementing these. The first option is to provide the on-chip buffer only for a certain maximum screen resolution, for example, for 1024×768 pixels. The second option is to store the buffer in the external video memory, and access it through a cache so that all accesses are on-chip for smaller resolutions.

Regarding, the tile classification information, in connection with the graphics processor 510 the tile classification information indicates only whether a tile is a boundary tile and may also indicate whether the tile is fully in shadow or fully lit after the processing of an entire shadow volume. This tile classification information is sufficient for distinguishing potential boundary tiles from non-boundary tiles, and allows processing of shadow polygons on a per-tile basis for non-boundary tiles. If, as discussed in connection with the graphics processor 610, the tile classification information indicates also whether a tile is fully lit or in shadow for at least non-boundary tiles, it is possible to enhance the processing of shadow polygons even further. This is so since a tile that is determined to be fully in shadow need not perform any per-pixel operations.

The tile classification information may indicate the potential boundary tiles and whether a tile is lit or in shadow for a non-boundary tile in various ways. One example is the one discussed above, where a Boolean boundary value indicates a potential boundary tile and a further value corresponding to a stencil value indicates the presence/absence of a shadow. A further example is to have for each tile two values, which are similar to stencil values. If these two values are equal, the tile is a non-boundary tile having the specified stencil value. If the values are different, the tile is a potential boundary tile. In this case, the two different values need not have any specific meaning.

It is possible to employ further encoding schemes for the tile classification information. It is appreciated that the tile classification information in this description and in the appended claims is intended to cover any information, which at minimum indicates whether a tile is a potential boundary tile. Tile classification information may additionally indicate the presence of a shadow for a non-boundary tile.

In connection with FIG. 6, tile-specific entries for storing stencil values (or, more generally, shadow information) were discussed. It is appreciated that the tile-specific entries of a stencil buffer (or other information store) may be implemented as combination of a Boolean value and a stencil value, the stencil value specifying a stencil value for a non-boundary tile. Alternatively, a tile-specific entry of a stencil buffer may be implemented as a pair of stencil values indicating a maximum and a minimum stencil value Sₘₐₓ and Sₘᵢₙ for a tile. Similarly as for the tile classification buffer, it is possible to employ further encoding schemes for the hierarchical stencil buffer. It is appreciated that a tile-specific entry for storing shadow information in this description and in the appended claims is intended to cover any information indicating whether a tile is a boundary tile and indicating whether a non-boundary tile is fully lit or in shadow.

Regarding FIG. 6, both a tile classification buffer and a hierarchical stencil buffer are employed in the graphics processor 610. The information contained in the tile classification buffer and in the tile-specific entries of the stencil buffer may have the same format, or the information may be different in these buffers. It is, however, noted that both the tile classification buffer and the hierarchical stencil buffer are typically needed, because more than one shadow volume may be processed at a time. The hierarchical stencil buffer contains information that the previously rendered shadow volumes have generated, while the temporary tile classification contains information only valid for a single shadow volume that is currently being processed. After the processing ends, the gathered information is incorporated into the hierarchical stencil buffer.

Regarding the information storage capacity for tile classifications and stencil values Sₘᵢₙ and Sₘₐₓ for each tile, it is noted that the tile classifications are usually 9 bits per tile, that is 8 bits for the value indicating presence/absence of shadow and 1 bit for the Boolean boundary value. As mentioned above, the value indicating presence/absence of shadow is usually similar to a stencil value. Regarding the stencil value for a tile in the temporary tile classification buffer, in the vast majority of cases, the shadow volume rasterization uses only a small subset of the 8-bit stencil buffer values. Therefore it is possible to limit the value for the tile classifications to, for example, to four bits. If the value overflows, the Boolean boundary value is set. This decreases the storage requirement for the temporary tile classification buffer to 5 bits per tile and does not cause visual artifacts. Regarding the tile-specific entries of the hierarchical stencil buffer, the minimum and maximum stencil values consist usually of 16 bits. The minimum and maximum stencil values are also useful for generic computations using stencil buffer. However, if the Sₘᵢₙ min and Sₘₐₓ values are used only for processing shadow polygons, their range could also be limited to four bits. Hence, the total size of on-chip buffers can be made much smaller than, for example, the existing zₘᵢₙ, zₘₐₓ buffers. A further alternative is to encode Sₘᵢₙ and Sₘₐₓ values so that they are only 1 bit each. In this case, “0” indicates lit and “1” means shadow, or vice versa. A boundary tile, that is a partial shadow, is marked with Sₘᵢₙ=0 and Sₘₐₓ=1. Employing this encoding in hardware may, however, involve some further modifications.

Another way to decrease the storage requirements for the temporary tile classification buffer is as follows. Since the sample point for hidden geometry can be placed at any point within the tile, it is possible to let four tiles, placed in a 2×2 configuration, share a common sample point. The common sample point is located at the shared corner of all four tiles. Thus these tiles can also share a tile classification. The storage for the tile classification information is then 1+8/4=3 bits, because the Boolean boundary value is still needed per tile. If an implementation with a four bit stencil value is used, then cost reduces to 1+4/4=2 bits per tile. It is furthermore possible that, for example, two adjacent tiles share a common sample point.

The continuous processing of several shadow volumes deserves special attention. The tile classifications are made for each shadow volume individually, and Stage 1 and Stage 2 are processing different shadow volumes. Therefore multiple temporary tile classification buffers are needed. It is possible to handle this by allocating a small number of tile classification buffers, according to the size of the render target, in the device driver. The buffers are stored in the external video memory and accessed through an on-chip cache. A temporary tile classification buffer is locked for a shadow volume in Stage 1 when the beginning of a shadow volume is encountered, for example, upon executing glBeginShadowVolume( ). If no buffers are available, the Stage 1 in FIG. 6 typically stalls. The buffer is released in Stage 2 upon encountering the end of the shadow volume, for example upon executing glEndShadowVolume( ). Only a part of each buffer is generally accessed by a shadow volume, and thus a fast clear bit per a set of tiles, for example, per 64×64 pixels provides a fast way of clearing the necessary parts of a tile classification buffer in Stage 1.

In FIG. 7 some examples are viewed in post-perspective space. FIG. 7 represents a row of tiles in the horizontal direction. The view direction is marked with an arrow. The depth values of the rendered geometry are shown with the linear curve, and the tile volumes can thus be inferred. The shadow volumes shown in FIG. 7 as gray areas are processed in one pass. This means that the shadow polygons relating to these shadow volumes have been processed together. In the upper-part of FIG. 7 the potential boundary tiles are marked with “B”. These potential boundary tiles need to be processed in more detail. Fully lit tiles marked with “L” and tiles in shadow are marked with “S”. Even in this simple example of FIG. 7, a significant number of tiles—namely the tiles marked with L and S—completely avoids all per-pixel rasterization work. As discussed above, the fully lit and in shadow tiles can be classified by considering only a single ray through an arbitrary point in the tile. Intersections of shadow polygons along that ray can be counted to perform the classification. It should be emphasized that depending on which point is chosen, the number of intersections of shadow polygons along the ray may change, but the end result is always the same. As an example of this, consider the shadow volume in FIG. 7 that resides completely in a single tile. Depending on which test point is used inside the tile, the shadow volume may be completely missed. Alternatively, the test point will register one back-facing shadow polygon and one front-facing shadow polygon, which cancel each other out. In both cases, the correct result is obtained: the shadow volume does not contribute to the visible shadow, and can therefore be culled.

The right-most example in FIG. 7 deserves some explanation. The two shadow volumes have been rendered within a single pass of the shadow volume algorithm. A slightly better culling rate would result, if the two shadow volumes were rendered separately, since the first shadow volume then would mark one of the second shadow volume's boundary tiles as fully in shadow.

In the description of the specific embodiments, a stencil buffer has been used for storing a shadow mask. It is appreciated that the classification of tiles into fully lit tiles, tiles in shadow or to boundary tiles may be applicable also in cases, where a stencil buffer is not used. For example, if the shadow volume is stored into a color buffer, any or all of the red (R), green (G), and blue (B) components can store the same contents as the stencil buffer. Alternatively, for colored light sources, R, G and B would hold different values. The contents of the color buffer can then be used to modulate the contents of an image of the rendered scene.

It is appreciated that although a hardware implementation of shadow volume algorithm is discussed above in detail, the present invention is also applicable to implementing shadow volume algorithms in software. When a general purpose computer is used for image processing, an image processing computer program code comprising instructions for carrying out the shadow volume algorithm is provided. The image processing computer program code typically provides the same functionality as graphics processors or an image processing method but in the form of computer execute procedures. The image processing computer program code may be a separate computer program, or it may be library code consisting procedures to be invoked by other computer programs. Various information stores for the image processing computer program code are usually provided by the random access memory of the general purpose computer.

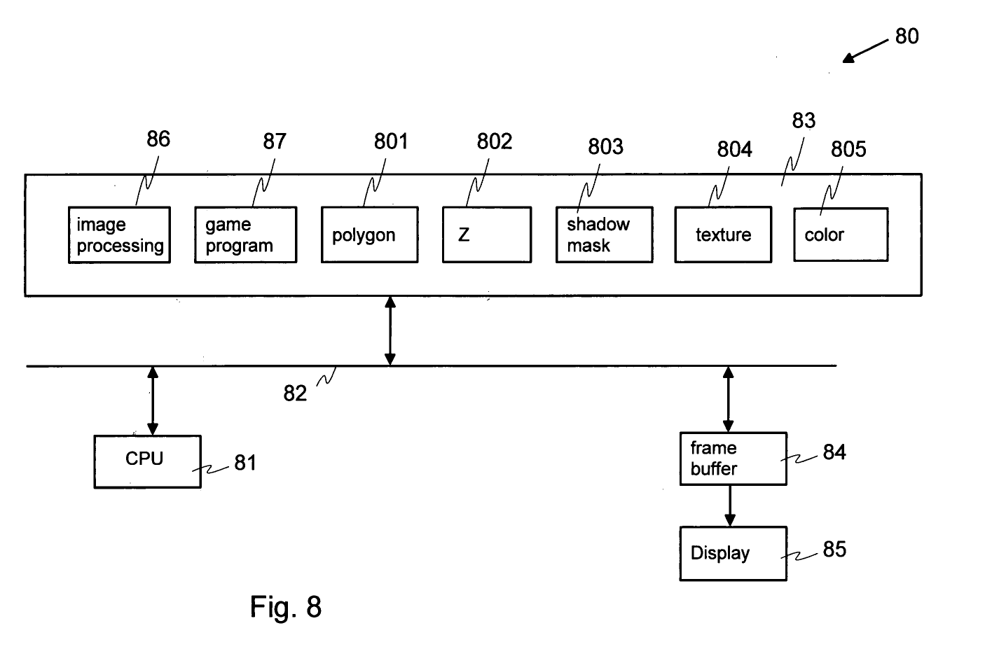

FIG. 8 shows, as an example, a schematic block chart of a general purpose computer 80 having a central processing unit CPU 81 connected to a bus 82, random access memory RAM 83 connected to the bus 82, and a frame buffer 84 connected to the bus 82 and to a display 85. The RAM 83 is used to store an image processing program 86 and, as an example, a game program 87. The image processing program 86 contains program code to be executed on the CPU 81. The images to be displayed may be images relating to scenes of the game program 87, meaning that information specifying the geometry of a scene originates from the game program 87. Various information stores needed by the image processing program are typically implemented in the RAM 83. FIG. 8 shows, as example, a polygon buffer 801, a Z buffer 802, a shadow mask buffer 803 corresponding to a stencil buffer, a texture buffer 804 and a color buffer 805. The image processing program is typically configured to write contents of the Z buffer 802 and of the color buffer 805 to the frame buffer 84 for displaying an image on the display 85.

As FIG. 8 shows the image processing program code is generally stored in the RAM, when the image processing program code is executed. For distribution, installation and storage, the image processing program code is typically provided on a computer readable recording medium, such as a CDROM.

The same process of determining whether at least shadow polygon of a current shadow volume intersects a tile volume can be used in other contexts as well. For example, in the culling pass of the soft shadow volume algorithm, one needs to determine quickly which pixels that can be affected by the penumbra region, and for those pixels a more expensive pixel shader needs to be executed. The culling pass of the soft shadow volume algorithm is discussed by U. Assarsson, M. Dougherty, M. Mounier, and T. Akenine-Möller, in “Optimized Soft Shadow Volume Algorithm with Real-Time Performance”, in Graphics Hardware, SIGGRAPH/EuroGraphics, pp. 33-40, 2003. Classifying tiles into potential boundary tiles and non-boundary tiles can be used to determine the pixels affected by the penumbra region as well in a straightforward manner, as the shadow volume algorithm forms part of the soft shadow volume algorithm. Furthermore, a shadow volume algorithm in accordance with an embodiment of the present invention may be applicable in any further algorithm for shadow information processing.

It is appreciated that although the specific embodiments of the invention refer to the z buffer and to the buffer containing zₘᵢₙ and zₘₐₓ values for each tile, a hardware implementation may omit one or both of these buffers. The performance of a graphics processor is, however, usually better if these buffers (or other information stores for storing this information) are used.

It is also appreciated that although the specific embodiments refer to processing tiles on a tile-basis or on a pixel-basis, other variations may exist. For example, it is possible that shadow mask is calculated for, say, two different tile sizes. As an example, tiles of 32×32 and 8×8 pixels may be used. These two different tile sizes can then be used adaptively. For example, if a given 32×32 tile is a non-boundary tile, it is not necessary to process separately the four 8×8 tiles forming the given 32×32 tile. On the other hand, if the given 32×32 tile is a potential boundary tile, at least one of the four 8×8 tiles forming the given 32×32 tile may be non-boundary tile. Furthermore, especially in implementing the invention by software, potential boundary tiles may be iteratively divided into smaller tiles and then classify these smaller tiles as potential boundary tiles or non-boundary tiles. In the iterative case, the shadow volume algorithm is finally carried on a per-pixel basis for the iteratively defined potential boundary tiles.

It is appreciated that although the hierarchical information store for shadow information has been discussed above in connection with the shadow volume algorithm, it is possible to use a hierarchical information store for shadow information also in connection with other ways to determine shadow information. A specific example of a store for shadow information is the stencil buffer. The above discussed specific examples of information stored the tile-specific entries of a tile classification buffer or tile-specific entries of the stencil buffer are applicable also to a hierarchical store for shadow information.

It is appreciated that information stored in a tile-specific entry of an information store for shadow information indicates at least a piece of shadow information for a tile and whether at least one further entry of said information store defines further shadow information for the tile. In other words, if tiles are classified into boundary and non-boundary tiles as discussed above, the indicated piece of shadow information for a tile indicates whether a non-boundary tile is fully lit or in shadow. The indication of whether further entries of the information store define further shadow information for the tile similarly indicates whether the respective tile is a non-boundary tile.

A hierarchical information store for shadow information has at least two levels of entries. Typically there are tile-specific entries and pixel-specific entries for storing shadow information. If different sizes of tiles are used, a larger tile containing a number of smaller tiles, it is possible that the hierarchical store has an entry level for each tile size. In this case, information stored in a tile-specific entry relating to a first larger tile may indicate that tile-specific entries relating to a number of second smaller tiles define further shadow information for the first tile. The tile-specific entry relating to a second smaller tile then refers, if needed, to pixel-specific entries. It is possible that for some tiles there are provided entries relating only to the largest tiles and to the pixel-specific entries, not to any intermediate tile size(s). It is clear to one skilled in the art that there are many ways to provide a hierarchical information store for shadow information in a manner which efficiently uses the storage capacity and allows efficient access to the entries.

FIG. 9a shows a simplified example of a tile 901 having 8×8 pixels. The shadow information relating to these pixels is shown in FIG. 9a as light squares representing lit pixels and dark squares representing pixels in shadow. FIGS. 9b and 9c show schematically some examples of entries of hierarchical information stores for storing shadow information. In these examples, the piece of shadow information is a stencil value and a stencil value larger than 0 indicates the presence of a shadow. Furthermore, in these examples the information stored in a tile-specific entry indicates presence of further shadow information for the tile with a further piece of information having a value equal to 0. As discussed above, many other encoding schemes may be applicable for the information stored in tile-specific entries. Examples of other encoding schemes are stencil value pairs Sₘᵢₙ and Sₘₐₓ and a combination of a stencil value and of a Boolean value.

FIG. 9b shows, as an example, schematically entries of a hierarchical two-level information store, the entries in FIG. 9b relating to the tile 901 shown in FIG. 9a. FIG. 9b shows a tile-specific entry 911 and pixel-specific entries as a table 912. The information in the tile-specific entry 911 contains a stencil (in entry 911 this stencil value is 0) and a further piece of information (in entry 911 this piece of information is 0). The tile-specific entry 911 thus indicates with the further piece of information equal to 0 that the pixel-specific entries shown in table 912 contain relevant shadow information for the tile 901. The stencil value stored in a tile-specific entry is typically relevant only when there is no further shadow information for the tile in further entries of the hierarchical information store.

FIG. 9c shows, as a second example, schematically entries of a hierarchical three-level information store, the entries in FIG. 9c relating to the tile 901 shown in FIG. 9a. In this example, the 8×8 tile is further divided into four 4×4 tiles. The encoding format for the information in the tile-specific entries is the same as in the example shown in FIG. 9b. The tile-specific entry 931 relates to the 8×8 tile. The tile-specific entries 932a, 932b, 932c and 932d relate to the four 4×4 tiles. As the 4×4 tile in the upper left corner of the tile 901 is fully lit and the 4×4 tile in the lower right corner of the tile 901 is fully in shadow, the tile-specific entries 932a and 932d have the further piece of information equal to 1. The stencil value in these tile-specific entries 932a and 932d is valid for the respective 4×4 tiles. The 4×4 tile in the upper right corner and the 4×4 tile in the lower left corner of the 8×8 tile 901 are partly in shadow. Therefore the tile-specific entries 932b and 932c indicate that there is further shadow information for each of these tiles in pixel-specific entries. The pixel-specific entries are shown as tables 933a and 933b.

As discussed above, the units accessing a hierarchical stencil buffer, or other hierarchical information store for shadow information, may determine based on the content of a tile-level entry whether there is need to access the relating pixel-specific entries of the shadow information store or, if applicable, whether there is need to access possible further tile-specific entries relating to smaller tiles. Information in a tile-specific entry thus typically indicates a piece of shadow information for the tile and whether relating pixel-specific entries or possible further tile-specific entries relating to smaller tiles define further relevant shadow information for the tile.

Regarding determining shadow information to be stored in a hierarchical information store, shadow information may be determined tile by tile and then stored to the hierarchical information store tile by tile. In this case, the tile-specific and pixel-specific entries of the information store may be updated in accordance with the shadow information determined for a tile. Resources are saved both in connection with storing shadow information and accessing shadow information in the hierarchical information store. Alternatively, it is possible that shadow information is not determined on a tile basis but, for example, on a pixel basis. In this case it is possible to store the shadow information to the pixel-specific entries and to update the tile-specific entries accordingly. In other words, if it is noticed that same shadow information is stored to all pixel-specific entries relating to a tile, the tile-specific entry may be updated to indicate that it is not necessary to access the pixel-specific entries for this tile. In this case, resources are saved at least in accessing the shadow information in the hierarchical information store. Further schemes for determining and storing shadow information may also be feasible in connection with a hierarchical information store for shadow information.

A hierarchical information store for shadow information may form a part of any device for image processing. A hierarchical information store for shadow information may be part of a processor for image processing, more particularly a part of a graphics processor. The implementation details discussed above in connection with the specific embodiments are also applicable to a processor or device for image processing using a hierarchical information store for shadow information.

Although preferred embodiments of the apparatus and method embodying the present invention have been illustrated in the accompanying drawings and described in the foregoing detailed description, it will be understood that the invention is not limited to the embodiments disclosed, but is capable of numerous rearrangements, modifications and substitutions without departing from the spirit of the invention as set forth and defined by the following claims.

1. A method for image processing in accordance with shadow polygons defining together a current shadow volume, the method comprising:
determining a set of tiles, each tile formed of a set of pixels, and respective tile volumes defined by the set of pixels and depth values relating to the set of pixels, and
determining whether a tile is a potential boundary tile or a non-boundary tile, a potential boundary tile having its tile volume intersected by at least one of the shadow polygons.

2. A method as defined in claim 1, comprising
carrying out a shadow volume algorithm for at least one point within a non-boundary tile for determining shadow information for the non-boundary tile, the shadow volume algorithm defining whether a point is in shadow or lit.

3. A method as defined in claim 2, wherein the step of carrying out the shadow volume algorithm comprises determining whether the non-boundary tile is fully lit or fully in shadow.

4. A method as defined in claim 3, wherein in the step of carrying out the shadow volume algorithm, it is determined jointly whether at least two non-boundary tiles are fully lit or fully in shadow by carrying out the shadow volume algorithm for a single point within all of the at least two non-boundary tiles.

5. A method as defined in claim 2, comprising
carrying out the shadow volume algorithm for a plurality of points of a potential boundary tile.

6. A method as defined in claim 2, comprising
carrying out the shadow volume algorithm for a point within each pixel of a potential boundary tile.

7. A method as defined in claim 2, wherein in the step carrying out the shadow volume algorithm, the shadow volume algorithm forms a part of a further algorithm for shadow information processing.

8. A method as defined in claim 1, further comprising
classifying non-boundary tiles into two groups, a first group relating to filly lit tiles and a second group relating to tiles in shadow.

9. A method as defined in claim 8, wherein the step of classifying non-boundary tiles comprises carrying out a shadow volume algorithm for a point within a non-boundary tile, the shadow volume algorithm defining whether a point is in shadow or lit.

10. A method as defined in claim 8, wherein the step of classifying non-boundary tiles comprises carrying out a shadow volume algorithm for a single point common to at least two non-boundary tiles, the shadow volume algorithm defining whether a point is in shadow or lit, thereby classifying jointly the at least two non-boundary tiles.

11. A method as defined in claim 8, comprising
storing, in tile-specific entries of an information store for storing shadow information, information indicating at least whether the respective tile is a non-boundary tile and indicating whether a non-boundary tile is fully lit or in shadow for the respective tile.

12. A method as defined in claim 11, further comprising
updating at least tile-specific entries of the information store for non-boundary tiles based on classifying the non-boundary tiles.

13. A method as defined in claim 12, further comprising
carrying out a shadow volume algorithm for the current shadow volume for a plurality of points belonging to a potential boundary tile, and
updating the information store for potential boundary tiles based on the shadow volume algorithm results.

14. A method as defined in 13, wherein the step of updating information store for potential boundary tiles comprises updating at least pixel-specific entries of the information store.

15. A method as defined in claim 14, further comprising
rasterizing shadow information for non-boundary tiles by accessing tile-specific entries of the information store, and
rasterizing shadow information for potential boundary tiles by accessing pixel-specific entries of the information store.

16. A method as defined in claim 15, further comprising
determining, based on the information stored in tile-specific entries of the information store, whether a tile is already in shadow due to other shadow volumes than the current shadow volume, and
skipping further handling of shadow polygon information relating to the current shadow volume for tiles already in shadow, irrespective of whether the tiles are potential boundary tiles.

17. A method as defined in claim 11, further comprising
rasterizing shadow information for non-boundary tiles by accessing tile-specific entries of the information store, and
rasterizing shadow information for potential boundary tiles by accessing pixel-specific entries of the information store.

18. A method as defined in claim 11, further comprising
determining, based on the information stored in tile-specific entries of the information store, whether a tile is already in shadow due to other shadow volumes than the current shadow volume, and
skipping further handling of shadow polygon information relating to the current shadow volume for tiles already in shadow, irrespective of whether the tiles are potential boundary tiles.

19. A method as defined in claim 1, wherein in the step of determining a set of tiles, tile volumes are defined by the set of pixels and minimum and maximum depth values relating to the set of pixels.

20. A processor for image processing in accordance with shadow polygons defining together a current shadow volume, said processor configured to
determine a set of tiles, each tile being formed of a set of pixels and having a respective tile volume defined by the set of pixels and depth values relating to the set of pixels, and
determine whether a tile is a potential boundary tile or a non-boundary tile, a potential boundary tile having a tile volume intersected by at least one of the shadow polygons.

21. A processor as defined in claims 20, wherein the processor is further configured to determine shadow information relating to the current shadow volume by carrying out a shadow volume algorithm for a point within a non-boundary tile and for a plurality of points within a potential boundary tile, the shadow volume algorithm defining whether a point is in shadow or lit.

22. A processor as defined in claim 21, wherein the processor is further configured to carry out a further algorithm for shadow information processing.

23. A processor as defined in claim 20, wherein the processor is further configured to classify non-boundary tiles into two groups, a first group relating to fully lit tiles and a second group relating to tiles in shadow.

24. A processor as defined in claim 23, further comprising an information store having tile-specific entries, the processor being configured to store in a tile-specific entry information indicating at least whether the respective tile is a non-boundary tile and whether a non-boundary tile is fully lit or in shadow for the respective tile.

25. A processor as defined in claim 24, wherein the information stored in a tile-specific entry of the information store contains a minimum stencil value and a maximum stencil value for the respective tile.

26. A processor as defined in claim 24, wherein the information stored in a tile-specific entry of the information store contains a stencil value and a further value indicating whether the stencil value is valid for the respective tile.

27. A processor as defined in claim 24, wherein the processor is configured to update at least pixel-specific entries of the information store for potential boundary tiles and at least tile-specific entries of the information store for non-boundary tiles.

28. A processor as defined in claim 27, wherein the processor is configured to rasterize shadow information for non-boundary tiles by accessing tile-specific entries of the information store and to rasterize shadow information for potential boundary tiles by accessing pixel-specific entries of the information store.

29. A processor as defined in claim 28, wherein the processor is configured to determine, based on the information stored in tile-specific entries of the information store, whether a tile is already in shadow due to other shadow volumes, and to skip further handling of shadow polygon information for tiles already in shadow, irrespective of whether the tiles are potential boundary tiles.

30. A processor as defined in claim 20, wherein a tile volume is defined by a set of pixels and minimum and maximum depth values relating to the set of pixels.

31. A processor as defined in claim 20, wherein the processor is a graphics processor.

32. A processor as defined in claim 20, wherein the processor is implemented on a single integrated circuit.

33. A processor for image processing in accordance with shadow polygons together defining a current shadow volume, the processor comprising
a first determining unit for determining a set of tiles, each tile being formed of a set of pixels and having a respective tile volume defined by the set of pixels and depth values relating to the set of pixels, and
a second determining unit for determining whether a tile is a potential boundary tile or a non-boundary tile, a potential boundary tile having a tile volume intersected by at least one of the shadow polygons.

34. A processor as defined in claim 33, comprising further
a first shadow information processing unit for determining shadow information relating to the current shadow volume for non-boundary tiles by carrying out a shadow volume algorithms for a point within a non-boundary tile, and
a second shadow information processing unit for determining shadow information relating to the current shadow volume for potential boundary tiles by carrying out a shadow volume algorithm for a plurality of points within a potential boundary tile.

35. A processor as defined in claim 34, wherein the processor is configured to delay shadow polygon information relating to the current shadow volume between the first shadow information processing unit and the second shadow information processing unit.

36. A processor as defined in claim 35, comprising a delay unit for delaying shadow polygon information relating to the current shadow volume.

37. A processor as defined in claim 36, the delay unit being a temporary store or a delay stream.

38. A processor as defined in claim 34, wherein the processor is configured to receive information relating to shadow polygons of the current shadow volume for a first time for inputting to the first shadow information processing unit and for a second time for inputting to the second shadow information processing unit.

39. A processor as defined in claim 34, further comprising an information store having tile-specific entries for storing information indicating at least whether the respective tile is a non-boundary tile and whether a non-boundary tile is fully lit or in shadow for the respective tile.

40. A processor as defined in claim 39, wherein the processor is configured to update at least tile-specific entries of the information store for non-boundary tiles, and at least pixel-specific entries of the information store for potential boundary tiles.

41. A processor as defined in claim 40, wherein the processor is configured to rasterize shadow information for non-boundary tiles by accessing tile-specific entries of the information store and to rasterize shadow information for potential boundary tiles by accessing pixel-specific entries of the information store.

42. A processor as defined in claim 41, wherein the processor is configured to determine, based on the information stored in tile-specific entries of the information store, whether a tile is already in shadow due to other shadow volumes, and to skip further handling of shadow polygon information for tiles already in shadow, irrespective of whether the tiles are potential boundary tiles.

43. A processor as defined in claim 33, wherein a tile volume is defined by a set of pixels and minimum and maximum depth values relating to the set of pixels.

44. A processor as defined in claim 33, wherein the processor is a graphics processor.

45. A processor as defined in claim 33, wherein the processor is implemented on a single integrated circuit.

46. A device for image processing in accordance with shadow polygons together defining a current shadow volume, said image processing device having a processor configured to
determine a set of tiles, each tile being formed of a set of pixels and having a respective tile volume defined by the set of pixels and depth values relating to the set of pixels, and
determine whether a tile is a potential boundary tile or a non-boundary tile, a potential boundary tile having a tile volume intersected by at least one of the shadow polygons.

47. A device as defined in claim 46, wherein the device is a graphics card or a graphics accelerator.

48. A computer readable recording medium that records an image processing program code for image processing in accordance with shadow polygons together defining a current shadow volume, said image processing program code having computer execute procedures comprising:
a first determining procedure for determining a set of tiles, each tile formed of a set of pixels, and respective tile volumes defined by the set of pixels and depth values relating to the set of pixels, and
a second determining procedure for determining whether a tile is a potential boundary tile or a non-boundary tile, a potential boundary tile having its tile volume intersected by at least one of the shadow polygons.

49. A processor for image processing, said processor comprising an information store for shadow information, said processor being configured to determine shadow information and to store shadow information in said information store,
wherein said information store has tile-specific entries, each tile being formed of a set of pixels, for storing information indicating at least a piece of shadow information for a tile and whether at least one further entry of said information store defines further shadow information for the tile.

50. A processor as defined in claim 49, wherein information stored in a tile-specific entry of said information store comprises a piece of shadow information for the respective tile and a further piece of information indicating whether at least one further entry of the information store defines at least one further piece of shadow information for the respective tile.

51. A processor as defined in claim 50, wherein information stored in a tile-specific entry of said information store comprises two pieces of shadow information.

52. A processor as defined in claim 51, wherein said two pieces of shadow information are two stencil values.

53. A processor as defined in claim 50, wherein a piece of shadow information is a stencil value.

54. A processor as defined in claim 49, wherein said information store for shadow information contains tile-specific entries and pixel-specific entries.

55. A processor as defined in claim 49, wherein said information store for shadow information comprises first tile-specific entries for a first set of tiles and second tile-specific entries for a second set of tiles, a tile of the first set of tiles comprising a number of tiles of the second set of tiles.

56. A processor as defined in claim 55, wherein said information store for shadow information comprises further pixel-specific entries.

57. A processor as defined in claim 49, wherein said information store for shadow information is a stencil buffer.

58. A processor as defined in claim 49, said processor being configured, for accessing shadow information stored in said information store, to first access a tile-specific entry of said information store and to access further entries relating to the tile based on the information stored in the tile-specific entry of said information store.

59. A device for image processing, said device comprising an information store for shadow information, said device being configured to determine shadow information and to store shadow information in said information store, wherein said information store has tile-specific entries, each tile being formed of a set of pixels, for storing information indicating at least a piece of shadow information for a tile and whether at least one further entry of said information store defines further shadow information for the tile.

60. A method for image processing, said method comprising:
determining shadow information, and
storing in a tile-specific entry of an information store, a tile being formed of a set of pixels, information indicating a piece of shadow information for a tile and whether at least one further entry of said information store defines further shadow information for the tile.

61. A method as defined in claim 60, further comprising
accessing information stored in a tile-specific entry of said information store, and
determining based on said information stored in said tile-specific entry a need to access further entries of the information store for accessing shadow information relating to the respective tile.

62. A computer readable recording medium that records an image processing program code for image processing, said image processing program code having computer execute procedures comprising:
a determining procedure for determining shadow information, and
a storing procedure for storing in a tile-specific entry of an information store, a tile being formed of a set of pixels, information indicating at least a piece of shadow information for a tile and whether at least one further entry of said information store defines further shadow information for the tile.
